(19) United States
(12) Patent Application Publication
(10) Pub. No.: US 2026/0055237 A1
(43) Pub. Date: Feb. 26, 2026

(54) POLYIMIDE OLIGOMER AND PREPARATION METHOD THEREFOR, AND CURED PRODUCT PREPARED THEREFROM

(71) Applicant: Swancor Innovation & Incubation Co., Ltd., Nantou County (TW)

(72) Inventors: Meng-Wei WANG, Nantou County (TW); Yun-Wen HUANG, Nantou County (TW); Jun-Qi KAO, Nantou County (TW)

(21) Appl. No.: 19/377,027

(22) Filed: Nov. 2, 2025

Related U.S. Application Data
(63) Continuation of application No. PCT/CN2023/093209, filed on May 10, 2023.

(51) Int. Cl. C08G 73/10; C08K 5/14

(52) U.S. Cl. CPC C08G 73/101; C08G 73/1042; C08K 5/14

(57) ABSTRACT

A polyimide oligomer and a preparation method therefor, and a cured product having low-dielectric properties prepared therefrom. The polyimide oligomer has a structure as represented by formula (I) or formula (II), and the symbols in formula (I) and formula (II) are as defined in the description. Therefore, a dimer diamine is used to match a specific monomer and a ratio is adjusted, so as to prepare a free-radical-curable polyimide oligomer; and same has good thermal properties and excellent low-dielectric properties after being cured, so as to be used in the industry of high-frequency circuit boards.

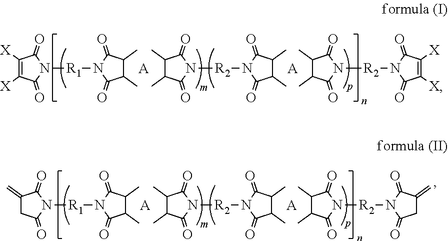

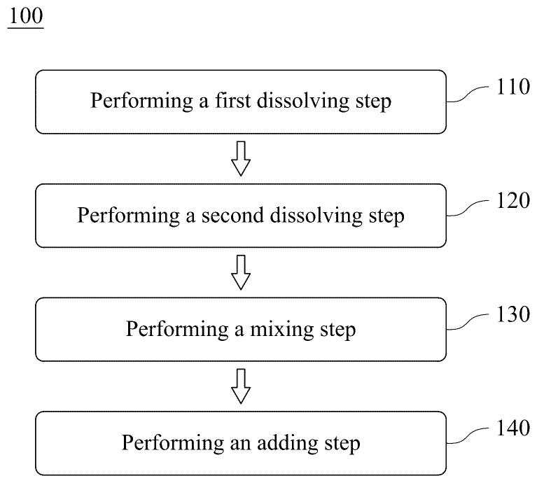

### CROSS-REFERENCE TO RELATED APPLICATION

This application is a continuation of International application No. PCT/CN2023/093209, filed May 10, 2023, the content of which is incorporated herein by reference in its entirety.

### BACKGROUND

### Field of Invention

The present disclosure relates to an oligomer, a preparation method therefor, and a cured product. More particularly, the present disclosure relates to a polyimide oligomer derived from a dimer diamine, a preparation method therefor, and a cured product prepared thereby.

### Description of Related Art

The rise of cloud technologies such as the internet and data centers has garnered significant attention for free radical curing systems in printed circuit board (PCB) applications. Noryl SA9000, marketed by SABIC Company, is a polyphenylene ether oligomer with terminal bifunctional acrylic groups. Its low molecular weight provides an excellent organic solubility and workability in impregnation processes. Thus, Noryl SA9000 imparts its fundamental physical property through free radical curing of the terminal acrylic groups. The inherent non-polar structure of polyphenylene ether, coupled with the absence of polar groups generated during the free radical curing, imparts excellent electrical property to the cured product, making Noryl SA9000 a mainstream material for high-end PCBs. However, the preparation process for Noryl SA9000 is challenging to purify and generates significant wastewater. For environmental reasons, developing viable materials with excellent electrical property and low process pollution can contribute to the development of PCB materials while addressing environmental concerns.

With the growing awareness of the environmental protection and carbon reduction in recent years, numerous studies have focused on the application of specialized bio-based diamines. For example, the dimerized diamine is mixed with the aromatic diamine monomer m-tolidine, and then polymerized with 4,4′-bisphenol A dianhydride (BPADA) to produce a high molecular weight polyimide (PI). Alternatively, the dimerized diamine is reacted with the dianhydride to produce polyimide oligomers or polymers with reactive terminal functional groups. Due to the bulky and branched structure of the dimerized diamine with a large free volume, its incorporation into materials is expected to impart a low dielectric property, resulting in excellent electrical performance in these polyimide materials. However, considerable room for improvement remains in terms of heat resistance.

In view of this, the goal of relevant industry players is to synthesize a free-radical curable polyimide oligomer derived from a bio-based diamine that overcomes the poor thermal property of diamine derivatives while simultaneously exhibiting high-frequency and a low dielectric property.

### SUMMARY

The purpose of the present disclosure provides a polyimide oligomer, a preparation method thereof, and a cured product prepared therefrom. By combining the dimerized diamine with other monomers and adjusting the ratio, the free radical-curable polyimide oligomer is obtained. The cured product has heat resistance and excellent electrical properties.

An embodiment of the present disclosure provides the polyimide oligomer having a structure as shown in formula (I) or formula (II):

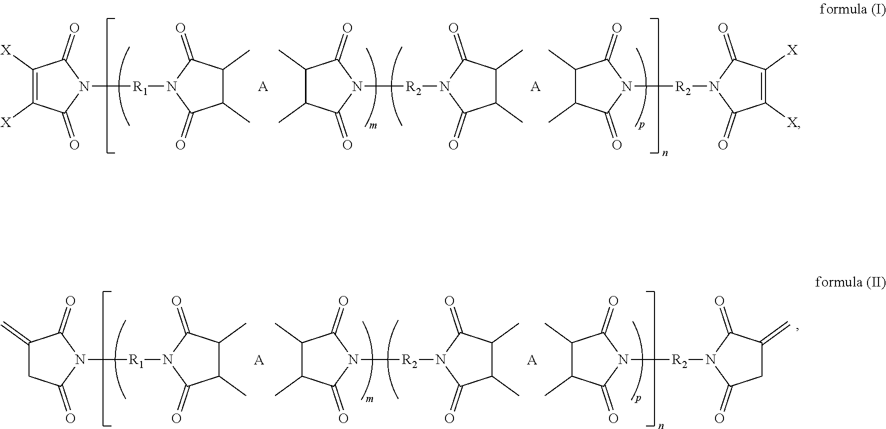

in which X are each independently hydrogen or a methyl group, and R₁ has a total carbon number of 5 to 20 and has a cycloalkane of 5 or more carbon numbers, a structure as shown in formula (A), formula (B), or formula (C):

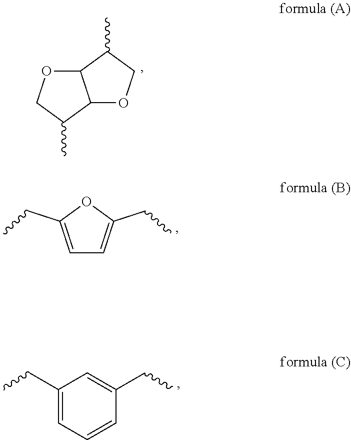

R₂ are each independently a saturated or an unsaturated hydrocarbon having 36 carbon atoms, and A are each independently a benzene ring, a biphenyl, a naphthalene ring, a cycloalkane with 4 to 6 carbon atoms, a structure as shown in formula (a), formula (b), formula (c), formula (d), formula (e), formula (f), formula (g), formula (h), or formula (i):

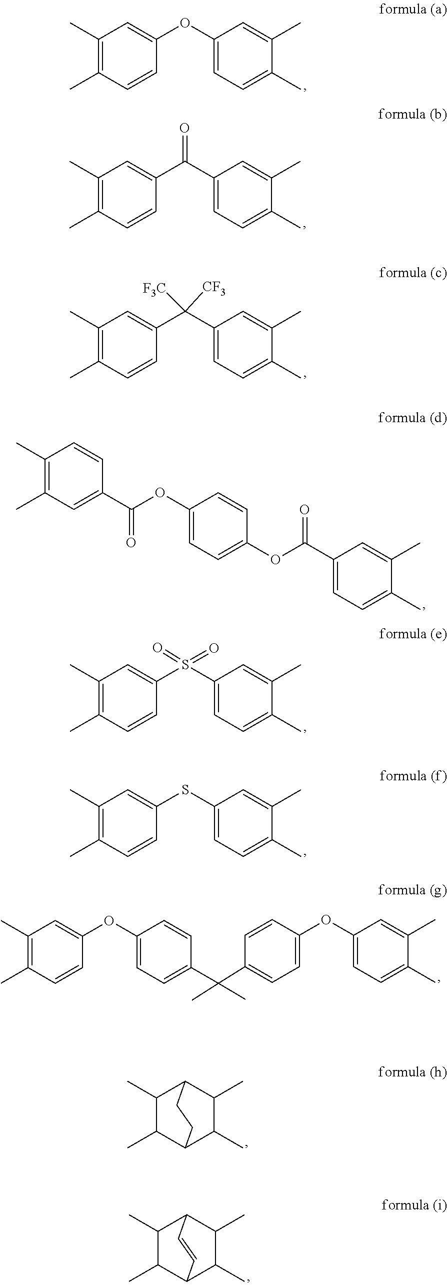

in which n is an arbitrary number from more than 0 to 10, and m/p is an arbitrary number from 0.5 to 5.

According to the polyimide oligomer described in the preceding paragraph, the cycloalkane of 5 or more carbon numbers can include a structure as shown in formula (D), formula (E), or formula (F):

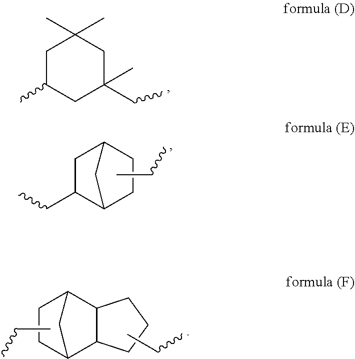

According to the polyimide oligomer described in the preceding paragraph, R₂ can have a structure as shown in formula (G), formula (H), formula (I), or formula (J):

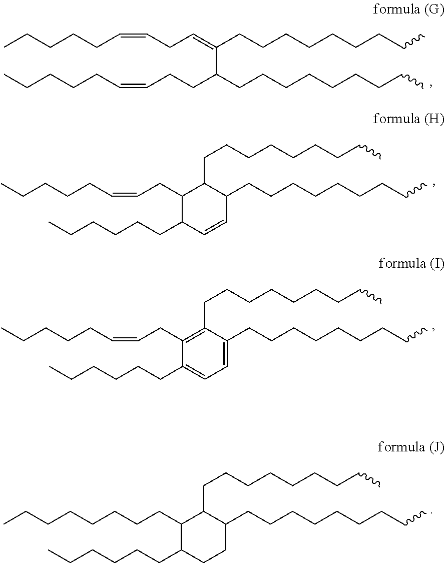

According to the polyimide oligomer described in the preceding paragraph, the polyimide oligomer may have a structure as shown in formula (I-1) or formula (II-1):

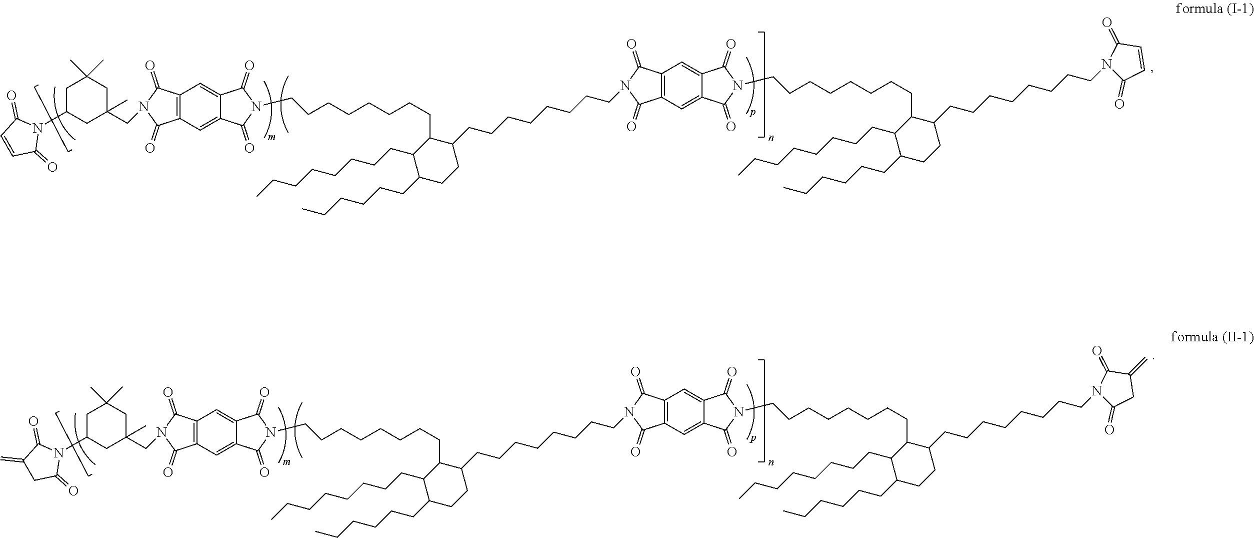

An another embodiment of the present disclosure provides a preparation method of the aforementioned polyimide oligomer including performing a first dissolving step, performing a second dissolving step, performing a mixing step, and performing an adding step. The first dissolving step is to dissolve a dianhydride and a monoanhydride in a first solvent to form an anhydride solution, in which the monoanhydride has an unsaturated double bond. The second dissolving step is to mix a dimerized diamine and a bifunctional fatty amine and dissolve the dimerized diamine and the bifunctional fatty amine in a second solvent to form a diamine solution, in which the bifunctional fatty amine has a cyclic structure. The mixing step is to add the diamine solution to the anhydride solution to react at a polymerization temperature to form a mixed solution. The adding step is to add xylene to the mixed solution and react and distill at a reaction distillation temperature to obtain the polyimide oligomer.

According to the preparation method of the aforementioned polyimide oligomer described in the preceding paragraph, the first solvent and the second solvent are selected from the group consisting of N,N-dimethylacetamide, N-methylpyrrolidinone, dimethylformamide, anisole, dimethyl sulfoxide, cyclohexanone, and m-benzenediol.

According to the preparation method of the aforementioned polyimide oligomer described in the preceding paragraph, the polymerization temperature is 0° C. to 90° C.

According to the preparation method of the aforementioned polyimide oligomer described in the preceding paragraph, the reaction distillation temperature is 130° C. to 170° C.

According to the preparation method of the aforementioned polyimide oligomer described in the preceding paragraph, a molar ratio of the dimerized diamine to the bifunctional fatty amine is 1:0.4 to 1:3.

According to the preparation method of the aforementioned polyimide oligomer described in the preceding paragraph, a molar ratio of a diamine to the dianhydride is 1.2:1 to 1.8:1, and the diamine is obtained by adding the dimerized diamine to the bifunctional fatty amine.

An another embodiment of the present disclosure provides a cured product being prepared by adding a free radical initiator to the aforementioned polyimide oligomer and baking at a curing temperature.

According to the aforementioned cured product described in the preceding paragraph, the free radical initiator is peroxide, an azo initiator, or a combination thereof.

According to the aforementioned cured product described in the preceding paragraph, an added amount of the free radical initiator is 0.3 weight percentage to 2 weight percentage of the polyimide oligomer.

The polyimide oligomer of the present disclosure is polymerized by using the dimerized diamine as a raw material and specific monomers, eliminating the need for purification. This result in reactive unsaturated double bonds at terminals of molecular chains, allowing for direct free radical thermal curing. After curing, the resulting product exhibits excellent heat resistance and electrical properties, making it a promising material for high-frequency circuit board applications.

### BRIEF DESCRIPTION OF THE DRAWINGS

To make the above and other purposes, features, advantages, and examples of the present disclosure more apparent, the following descriptions of the accompanying drawings are given.

The FIGURE is flowchart illustrating a method for preparing a polyimide oligomer according to an embodiment of the present disclosure.

### DETAILED DESCRIPTION

Reference will now be made in detail to the present embodiments of the disclosure. However, the embodiment can be an application of various inventive concepts and can be embodied in various specific scopes. The specific embodiments are for illustrative purposes only and are not intended to limit the scope of the disclosure.

In the present disclosure, compound structures are sometimes represented using skeleton formulas. The representation may omit carbon atoms, hydrogen atoms, and carbon-hydrogen bonds. If a functional group is explicitly depicted in a structural formula, the depicted group shall prevail.

In the present disclosure, “a polyimide oligomer having a structure as shown in formula (I)” may sometimes be expressed as “polyimide oligomer as shown in formula (I)” or “polyimide oligomer (I)” for concise and fluent. The same applies to other compounds or groups.

In the present disclosure, unless a group is specifically designated as substituted, it may represent either a substituted or unsubstituted group. For example, “alkyl group” may represent either a substituted or unsubstituted alkyl group.

### <The Polyimide Oligomer>

The present disclosure provides the polyimide oligomer having a structure as shown in formula (I) or formula (II):

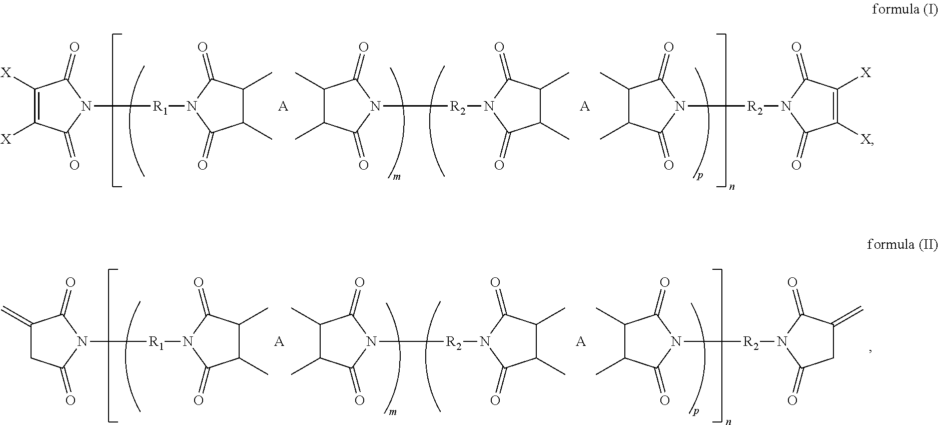

in which X are each independently hydrogen or a methyl group, and R₁ has a total carbon number of 5 to 20 and has a cycloalkane of 5 or more carbon numbers, a structure as shown in formula (A), formula (B) or formula (C):

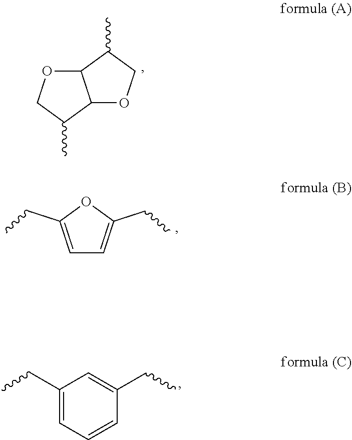

R₂ are each independently a saturated or an unsaturated hydrocarbon having 36 carbon atoms, and A are each independently a benzene ring, a biphenyl, a naphthalene ring, a cycloalkane with 4 to 6 carbon atoms, a structure as shown in formula (a), formula (b), formula (c), formula (d), formula (e), formula (f), formula (g), formula (h), or formula (i):

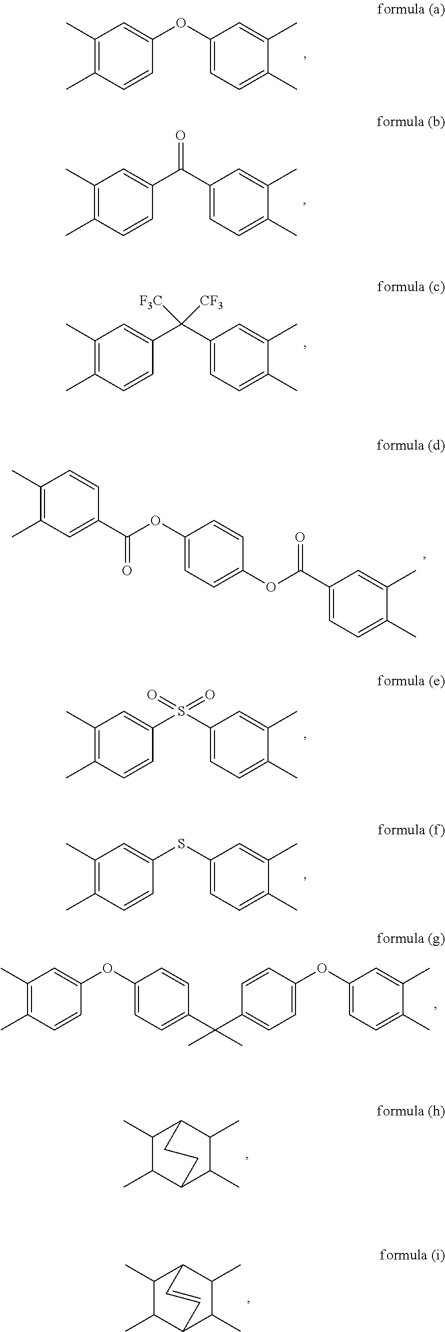

in which n is an arbitrary number from more than 0 to 10, and m/p is an arbitrary number from 0.5 to 5.

In detail, the cycloalkane of 5 or more carbon numbers can include a structure as shown in formula (D), formula (E), or formula (F):

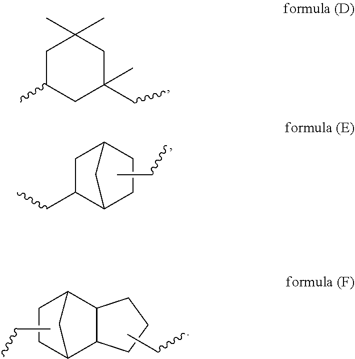

However, the present disclosure is not limited thereto. Besides, R₂ can have a structure as shown in formula (G), formula (H), formula (I), or formula (J):

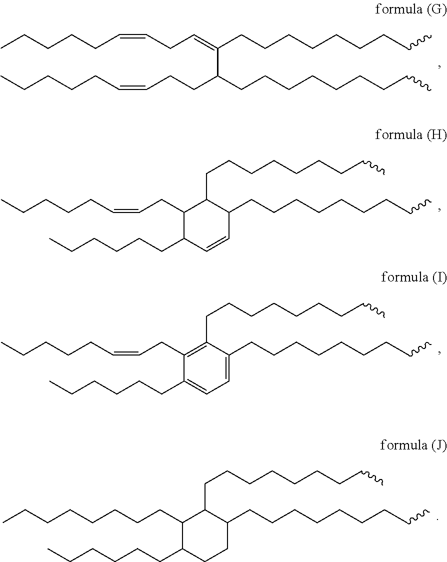

For example, when, in the polyimide oligomer as shown in formula (I) or formula (II), X is hydrogen, R₁ is a structure as shown in formula (D), R₂ is a structure as shown in formula (J), and A is a benzene ring, the polyimide oligomer has a structure as shown in formula (I-1) or formula (II-1):

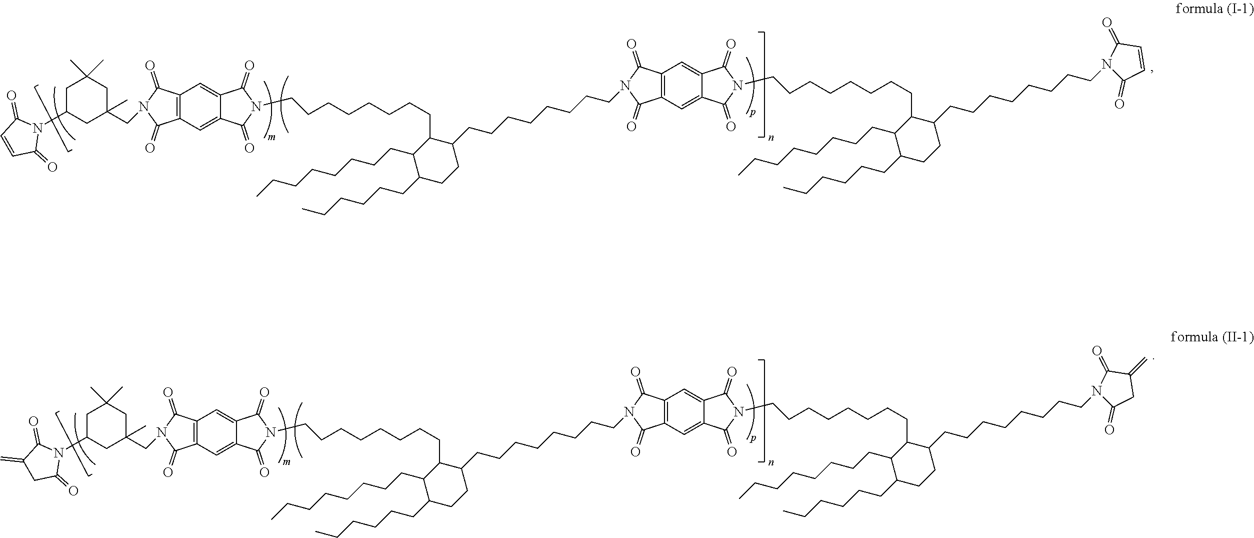

The polyimide oligomer of the present disclosure is derived from a dimerized diamine and has reactive unsaturated double bonds at its terminal. It can be cured by free radical polymerization to form a cured product with excellent mechanical property and heat resistance. Furthermore, since the main structure is composed of a large number of aliphatic carbon chains, it can provide the material with excellent a low dielectric property and has considerable potential for application in printed circuit board materials.

### <A Preparation Method of the Polyimide Oligomer>

Refer to the FIGURE, which is a flowchart of a method for preparing the polyimide oligomer 100 according to an embodiment of the present disclosure. In the FIGURE, the method for preparing the polyimide oligomer 100 includes step 110, step 120, step 130, and step 140.

Step 110 is performing a first dissolving step by dissolving a dianhydride and a monoanhydride in a first solvent to form an anhydride solution, and the monoanhydride has an unsaturated double bond to meet the subsequent free radical curing requirements. Specifically, the monoanhydride may be, but is not limited to, maleic anhydride or itaconic anhydride.

Step 120 is performing a second dissolving step by mixing a dimerized diamine and a bifunctional fatty amine and dissolving the dimerized diamine and the bifunctional fatty amine in a second solvent to form a diamine solution, in which a molar ratio of the dimerized diamine to the bifunctional fatty amine may be 1:0.4 to 1:3. More preferably, 1:0.5 to 1:2. In detail, the dimerized diamine is a bio-based diamine, which is a diamine monomer derived from fatty acids, and the main structure is a multi-carbon aliphatic group. The bifunctional fatty amine has a cyclic structure to provide good heat resistance for subsequent free radical curing derivatives. Specifically, the bifunctional fatty amine can be, but is not limited to, isophorone diamine or protobornene diamine.

Besides, the first solvent of step 110 and the second solvent of the step 120 can be the same or different, and are selected from the group consisting of N,N-dimethylacetamide (DMAc), N-methylpyrrolidinone (NMP), dimethylformamide (DMF), anisole, dimethyl sulfoxide (DMSO), cyclohexanone, and m-benzenediol.

Step 130 is performing a mixing step by adding the diamine solution to the anhydride solution to react at a polymerization temperature to form a mixed solution, in which the polymerization temperature is 0° C. to 90° C. Preferably, 40° C. to 80° C. After the diamine solution is added to the anhydride solution, the polymerization is carried out at the polymerization temperature. A molar ratio of a diamine to the dianhydride is 1.2:1 to 1.8:1, preferably 1.4:1 to 1.6:1, and the diamine is obtained by adding the dimerized diamine to the bifunctional fatty amine.

Step 140 is performing an adding step by adding xylene to the mixed solution and reacts and distills at a reaction distillation temperature to obtain the polyimide oligomer, in which the reaction distillation temperature is 130° C. to 170° C., preferably, 140° C. to 160° C. In detail, after the xylene is added to the mixed solution, a Dean-Stark apparatus is set up and the temperature is raised to the reaction distillation temperature for a closed-loop reaction and distillation to remove water. After cooling, a polyimide oligomer solution containing the polyimide oligomer and a solvent is obtained.

### <A Cured Product>

The present disclosure provides the cured product being prepared by adding a free radical initiator to the aforementioned polyimide oligomer and baking at a curing temperature, in which the free radical initiator may be peroxide, an azo initiator, or a combination thereof. An added amount of the free radical initiator may be 0.3 weight percentage to 2 weight percentage of the polyimide oligomer, preferably, 0.5 weight percentages to 1.5 weight percentages. Besides, the free radical curing reaction can be carried out by heating in a stepwise manner, but is not limited to this heating method.

Thus, the method for preparing the polyimide oligomer of the present disclosure overcomes the problem of the poor thermal property after curing by selecting and matching amines and adjusting their proportions, while maintaining the high-frequency and low dielectric property. Furthermore, due to the improved monomer selection and feeding sequence, the polyimide oligomer can be produced without the addition of a catalyst and can be directly used in the circuit board impregnation process, reducing waste liquid production and solvent usage, thereby balancing the development of the circuit board industry and carbon reduction trends.

The present disclosure is further illustrated by the following specific examples, which are intended to facilitate those skilled in the art to which the present disclosure relates, so that they can fully utilize and practice the present disclosure without excessive interpretation. These examples should not be construed as limiting the scope of the present disclosure, but are intended to illustrate how to implement the materials and methods of the present disclosure.

### THE EXAMPLES AND THE COMPARATIVE EXAMPLES

Example 1:20 g (0.0917 mole) of pyromellitic dianhydride (PMDA) and 8.99 g (0.0917 mole) of maleic anhydride were dissolved in 90 g of N,N-dimethylacetamide (DMAc) to prepare an anhydride solution. Next, 36.79 g (0.0688 mole) of dimerized diamine (Priamine 1075, purchased from Croda) and 11.71 g (0.0688 mole) of isophorone diamine (IPDA) were dissolved in 73 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 54 g of xylene was added to form a mixed solution to be separated. The polyimide oligomer solution was then separated from the mixed solution by distillation. For example, using the Dean-Stark apparatus, the mixed solution was heated to 150° C. to remove water for 4 hours. The temperature was then further raised to 160° C. to remove water until the desired amount of water was removed, and the solution was cooled to obtain the polyimide oligomer solution of Example 1. Specifically, the polyimide oligomer of Example 1 has the structure shown in formula (I-1), in which m/p is 1. After measured by a gel permeation chromatography (GPC), the number average molecular weight (Mn) is 2095, and the weight average molecular weight (Mw) is 4841.

Example 2:20 g (0.0917 mole) of pyromellitic dianhydride and 8.99 g (0.0917 mole) of maleic anhydride were dissolved in 90 g of N,N-dimethylacetamide to prepare an anhydride solution. Next, 24.53 g (0.0459 mole) of dimerized diamine (Priamine 1075, purchased from Croda) and 15.62 g (0.0917 mole) of isophorone diamine were dissolved in 56.54 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 48.85 g of xylene was added, and the remaining steps are the same as those in Example 1 to obtain the polyimide oligomer solution of Example 2. Specifically, the polyimide oligomer of Example 2 has the structure shown in formula (I-1), in which m/p is 2. After measured by the gel permeation chromatography (GPC), the number average molecular weight (Mn) is 1448, and the weight average molecular weight (Mw) is 3049.

Example 3:20 g (0.0917 mole) of pyromellitic dianhydride and 8.99 g (0.0917 mole) of maleic anhydride were dissolved in 90 g of N,N-dimethylacetamide (DMAc) to prepare an anhydride solution. Next, 49.05 g (0.0917 mole) of dimerized diamine (Priamine 1075, purchased from Croda) and 7.81 g (0.0458 mole) of isophorone diamine were dissolved in 90.07 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 60.02 g of xylene was added, and the remaining steps are the same as those in Example 1 to obtain the polyimide oligomer solution of Example 3. Specifically, the polyimide oligomer of Example 3 has the structure shown in formula (I-1), in which m/p is 0.5. After measured by the gel permeation chromatography (GPC), the number average molecular weight (Mn) is 1050, and the weight average molecular weight (Mw) is 2373.

Example 4:20 g (0.0917 mole) of pyromellitic dianhydride and 10.28 g (0.0917 mole) of itaconic anhydride were dissolved in 90 g of N,N-dimethylacetamide (DMAc) to prepare an anhydride solution. Next, 24.53 g (0.0459 mole) of dimerized diamine (Priamine 1075, purchased from Croda) and 15.62 g (0.0917 mole) of isophorone diamine were dissolved in 56.54 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 48.85 g of xylene was added, and the remaining steps are the same as those in Example 1 to obtain the polyimide oligomer solution of Example 4. Specifically, the polyimide oligomer of Example 4 has the structure shown in formula (II-1), in which m/p is 2. After measured by the gel permeation chromatography (GPC), the number average molecular weight (Mn) is 2235, and the weight average molecular weight (Mw) is 5669.

Comparative Example 1:20 g (0.0917 mole) of pyromellitic dianhydride and 8.99 g (0.0917 mole) of maleic anhydride were dissolved in 90 g of N,N-dimethylacetamide (DMAc) to prepare an anhydride solution. Next, 23.42 g (0.1375 mole) of isophorone diamine was dissolved in 24.14 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 38.14 g of xylene was added, and the remaining steps are the same as those in Example 1 to obtain the polyimide oligomer solution of Comparative Example 1. Specifically, after Comparative Example 1 was measured by the gel permeation chromatography (GPC), the number average molecular weight (Mn) is 2117, and the weight average molecular weight (Mw) is 2950.

Comparative Example 2:20 g (0.0917 mole) of pyromellitic dianhydride and 1.798 g (0.0813 mole) of maleic anhydride were dissolved in 80 g of N,N-dimethylacetamide (DMAc) to prepare an anhydride solution. Next, 26.98 g (0.0504 mole) of dimerized diamine (Priamine 1075, purchased from Croda) and 8.59 g (0.0504 mole) of isophorone diamine were dissolved in 39.6 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 39.87 g of xylene was added, and the remaining steps are the same as those in Example 1. However, during the preparation process, a large amount of salts were generated and difficult to eliminate, resulting in the inability to obtain the product smoothly. The reason is that the molar ratio of diamine to dianhydride is changed to 1.1:1.

Comparative Example 3:20 g (0.0917 mole) of pyromellitic dianhydride and 8.99 g (0.0917 mole) of maleic anhydride were dissolved in 90 g of N,N-dimethylacetamide to prepare an anhydride solution. Next, 36.79 g (0.0688 mole) of dimerized diamine (Priamine 1075, purchased from Croda) and 11.71 g (0.0688 mole) of isophorone diamine were dissolved in 73 g of N,N-dimethylacetamide to prepare a diamine solution. The diamine solution was then slowly dripped into the anhydride solution. However, the reaction was violent during the addition process, causing the reaction to gel quickly and the product could not be obtained smoothly. The reason was that the diamine solution and the anhydride solution were added in different orders.

Comparative Example 4:20 g (0.0917 mole) of pyromellitic dianhydride and 8.99 g (0.0917 mole) of maleic anhydride were dissolved in 90 g of N,N-dimethylacetamide (DMAc) to prepare an anhydride solution. Next, 73.58 g (0.1375 mole) of dimerized diamine (Priamine 1075, purchased from Croda) was dissolved in 127.28 g of N,N-dimethylacetamide to prepare a diamine solution. The diamine solution was then slowly dripped into the anhydride solution in a water bath controlled not to exceed 60° C. After the dripping was complete, the temperature was raised to 80° C. and the reaction was allowed to proceed for 3 hours. Afterward, 72.43 g of xylene was added, and the remaining steps are the same as those in Example 1 to obtain the polyimide oligomer solution of Comparative Example 4. Specifically, after Comparative Example 4 was measured by the gel permeation chromatography (GPC), the number average molecular weight (Mn) is 1937, and the weight average molecular weight (Mw) is 2480.

### <Preparation of the Cured Products>

Example 5:5 g of the polyimide oligomer solution (30% solid content, DMAc as solvent) of Example 1 was added with 0.015 g (1 wt % of the polyimide oligomer) of dicumyl peroxide (DCP) to prepare a prepolymer solution. The prepolymer solution was then poured into a mold and baked slowly at a temperature of 80° C. to 140° C. to remove the solvent. The solution was then further heated to cure. The curing process employed a staged heating. In this example, a three-stage curing process was employed, with curing at 180° C., 200° C., and 220° C. for 2 hours each, to obtain the cured product of Example 5.

Example 6:5 g of the polyimide oligomer solution (30% solid content, DMAc as solvent) of Example 2 was added with 0.015 g (1 wt % of the polyimide oligomer) of dicumyl peroxide to prepare a prepolymer solution. The prepolymer solution was then poured into a mold. The remaining steps were the same as in Example 5 to obtain the cured product of Example 6.

Example 7:5 g of the polyimide oligomer solution (30% solid content, DMAc as solvent) of Example 3 was added with 0.015 g (1 wt % of the polyimide oligomer) of dicumyl peroxide to prepare a prepolymer solution. The prepolymer solution was then poured into a mold. The remaining steps were the same as in Example 5 to obtain the cured product of Example 7.

Example 8:5 g of the polyimide oligomer solution (30% solid content, DMAc as solvent) of Example 4 was added with 0.015 g (1 wt % of the polyimide oligomer) of dicumyl peroxide to prepare a prepolymer solution. The prepolymer solution was then poured into a mold. The remaining steps were the same as in Example 5 to obtain the cured product of Example 8.

Comparative Example 5:5 g of the polyimide oligomer solution (30% solid content, DMAc as solvent) of Comparative Example 1 was added with 0.015 g (1 wt % of the polyimide oligomer) of dicumyl peroxide to prepare a prepolymer solution. The prepolymer solution was then poured into a mold. The remaining steps were the same as in Example 5 to obtain the cured product of Comparative Example 5. However, it had severe foaming and high brittleness, making it difficult to successfully produce a complete membrane material.

Comparative Example 6:5 g of the polyimide oligomer solution (30% solid content, DMAc as solvent) of Comparative Example 4 was added with 0.015 g (1 wt % of the polyimide oligomer) of dicumyl peroxide to prepare a prepolymer solution. The prepolymer solution was then poured into a mold. The remaining steps were the same as in Example 5 to obtain the cured product of Comparative Example 6.

Comparative Example 7:5 g of the polyphenylene ether resin (Noryl SA9000, purchased from SABIC) was added with 0.015 g of dicumyl peroxide to prepare a prepolymer solution. The prepolymer solution was then poured into a mold. The remaining steps were the same as in Example 5 to obtain the cured product of Comparative Example 7.

### <Evaluation Test Methods>

Glass transition temperature (Tg): a dynamic mechanical analyzer (DMA) is used to measure the glass transition temperature of the cured products at a heating rate of 5° C./min.

Dielectric analysis method: to evaluate the dielectric property of the cured products obtained by curing the polyimide oligomer of the present disclosure, and the present disclosure measures dielectric constant (Dₖ) and dielectric loss (D_{f}) of the cured products at 10 GHz.

The above evaluation test methods were performed on Examples 5 to 8 and Comparative Examples 6 to 7, and the results are recorded in Table 1.

TABLE 1

| | T_{g} (° C.) | Dₖ | D_{f} |
|---|---|---|---|
| Example 5 | 132 | 2.57 | 0.0038 |
| Example 6 | 193 | 2.69 | 0.0048 |
| Example 7 | 115 | 2.21 | 0.0027 |
| Example 8 | 180 | 2.78 | 0.0055 |
| Comparative | 35 | 2.23 | 0.0018 |
| Example 6 | | | |
| Comparative | 228 | 2.77 | 0.0071 |
| Example 7 | | | |

As shown in Table 1 above, after free radical curing of the polyimide oligomers of Examples 1 to 4, the glass transition temperature of the cured products of Examples 5 to 8 obtained are all above 100° C. Furthermore, as the amount of rigid isophorone diamine increases, the glass transition temperature of Examples 6 and 8 reaches above 180° C. Although the heat resistance of the cured products of Examples 6 and 8 are inferior to Comparative Example 7 prepared by using the currently widely used polyphenylene ether resin SA9000, the heat resistances of the cured products of Examples 5 to 8 are significantly improved compared to the cured product of Comparative Example 6, which does not contain rigid isophorone diamine.

Furthermore, the cured products of Examples 5 to 8 exhibit superior insulation property under high-frequency measurements compared to Comparative Example 7, which is made with the currently widely used polyphenylene ether resin SA9000. For Example 6, which exhibits the best heat resistance, its dielectric constant (Dₖ) is comparable to that of Comparative Example 7, but its dielectric loss (D_{f}) is significantly improved. However, increasing the amount of dimerized diamine used further improves the insulation property of the resulting cured products. For Example 7, which uses the highest amount of dimerized diamine, its dielectric constant (Dₖ) reaches 2.21 and its dielectric loss (D_{f}) reaches 0.0027, demonstrating excellent electrical performance and suitable for use in the production of high-frequency printed circuit boards.

Furthermore, the cured product of Comparative Example 6, which lacks the addition of rigid diamine, does not exhibit superior dielectric constant (Dₖ) performance compared to Example 7. However, the dielectric loss (D_{f}) performance of Comparative Example 6 is further optimized to 0.0018. This indicates that the contribution of the diamine structure to the dielectric constant (Dₖ) gradually decreases after a certain usage level, further improving dielectric loss (D_{f}). However, Comparative Example 6 exhibits significant heat resistance degradation, limiting its application in circuit board applications requiring heat resistance.

In summary, the polyimide oligomer of the present disclosure, using the dimerized diamine as a raw material and a rigid bifunctional diamine monomer, has indeed improved the heat resistance while maintaining good electrical property. The material even exhibits electrical property superior to those of the currently widely used polyphenylene ether resin. This demonstrates the potential application of the polyimide oligomer in the circuit board industry and can alleviate the environmental issues associated with material development.

Although the present disclosure has been disclosed above in terms of embodiments, it is not intended to limit the present disclosure. Those skilled in the art may make various changes and modifications without departing from the spirit and scope of the present disclosure. Therefore, the scope of protection of the present disclosure shall be determined by the appended claims.

What is claimed is:

1. A polyimide oligomer, having a structure as shown in formula (I) or formula (II): 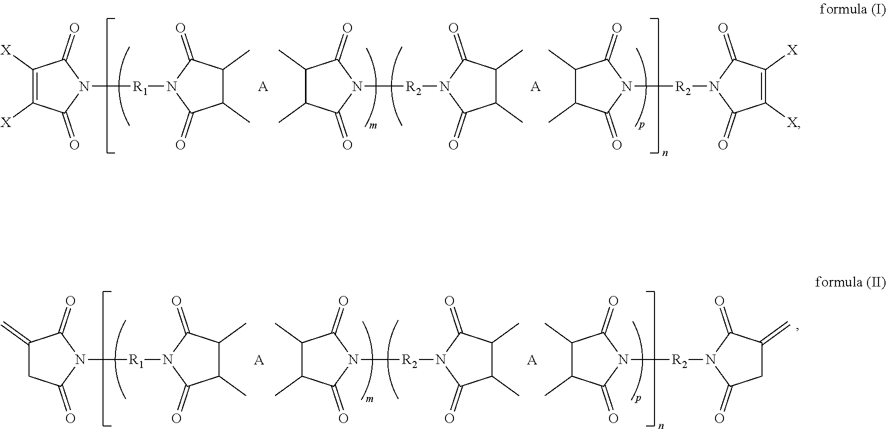
wherein X are each independently hydrogen or a methyl group, R₁ has a total carbon number of 5 to 20 and has a cycloalkane of 5 or more carbon numbers, a structure as shown in formula (A), formula (B), or formula (C): 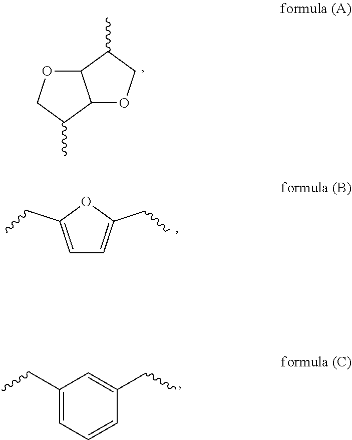
R₂ are each independently a saturated or an unsaturated hydrocarbon having 36 carbon atoms, A are each independently a benzene ring, a biphenyl, a naphthalene ring, a cycloalkane with 4 to 6 carbon atoms, a structure as shown in formula (a), formula (b), formula (c), formula (d), formula (e), formula (f), formula (g), formula (h), or formula (i): 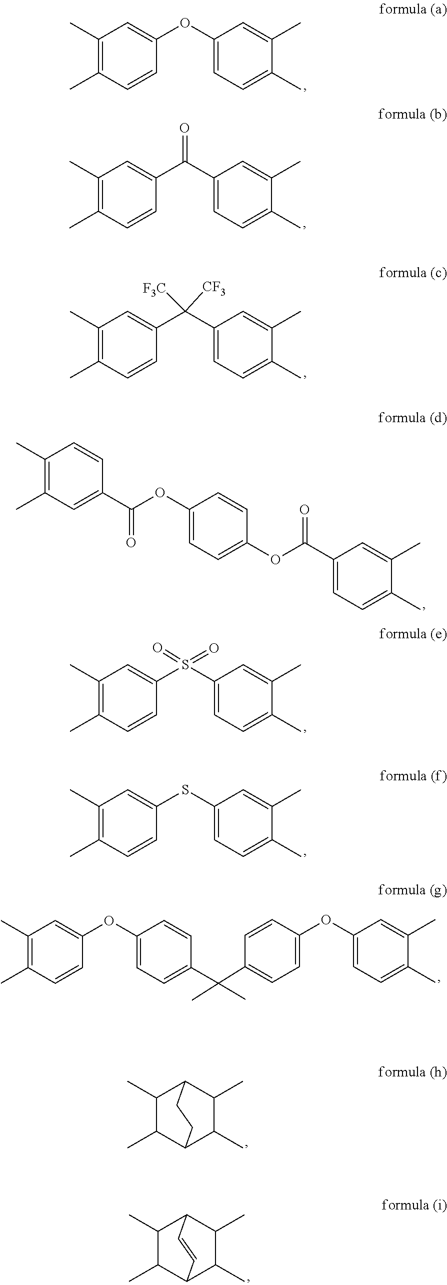
wherein n is an arbitrary number from more than 0 to 10, and m/p is an arbitrary number from 0.5 to 5.

2. The polyimide oligomer of claim 1, wherein the cycloalkane of 5 or more carbon numbers comprises a structure as shown in formula (D), formula (E), or formula (F):

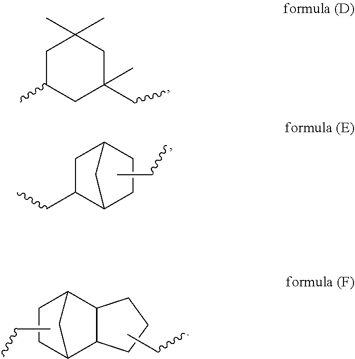

3. The polyimide oligomer of claim 1, wherein R₂ has a structure as shown in formula (G), formula (H), formula (I), or formula (J):

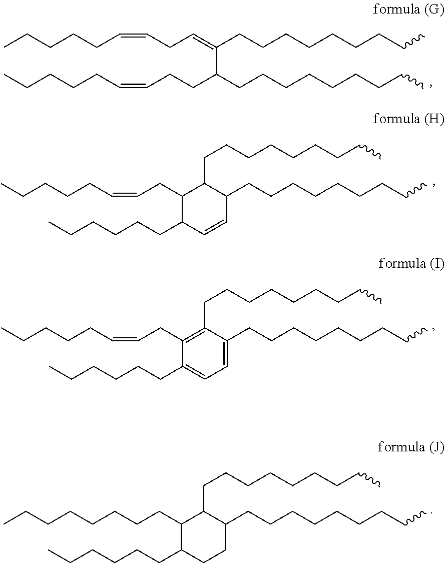

4. The polyimide oligomer of claim 1, wherein the polyimide oligomer has a structure as shown in formula (I-1) or formula (II-1):

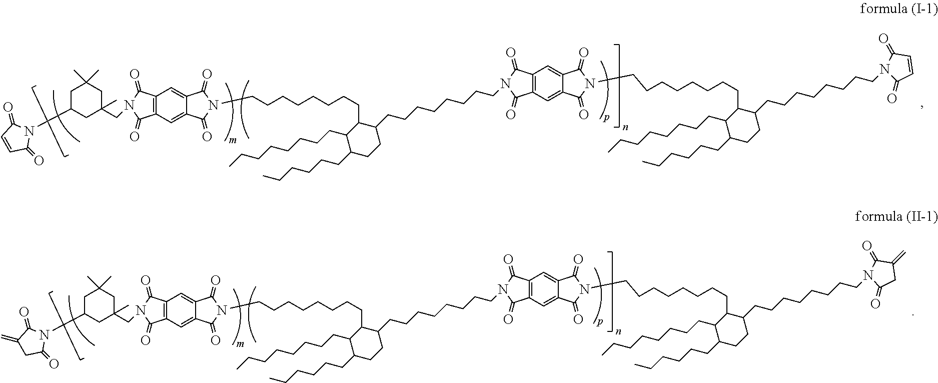

5. A preparation method of the polyimide oligomer of claim 1, comprising:
performing a first dissolving step by dissolving a dianhydride and a monoanhydride in a first solvent to form an anhydride solution, wherein the monoanhydride has an unsaturated double bond;
performing a second dissolving step by mixing a dimerized diamine and a bifunctional fatty amine and dissolving the dimerized diamine and the bifunctional fatty amine in a second solvent to form a diamine solution, wherein the bifunctional fatty amine has a cyclic structure;
performing a mixing step by adding the diamine solution to the anhydride solution to react at a polymerization temperature to form a mixed solution; and
performing an adding step by adding xylene to the mixed solution and reacting and distilling at a reaction distillation temperature to obtain the polyimide oligomer.

6. The preparation method of the polyimide oligomer of claim 5, wherein the first solvent and the second solvent are selected from the group consisting of N,N-dimethylacetamide, N-methylpyrrolidinone, dimethylformamide, anisole, dimethyl sulfoxide, cyclohexanone, and m-benzenediol.

7. The preparation method of the polyimide oligomer of claim 5, wherein the polymerization temperature is 0° C. to 90° C.

8. The preparation method of the polyimide oligomer of claim 5, wherein the reaction distillation temperature is 130° C. to 170° C.

9. The preparation method of the polyimide oligomer of claim 5, wherein a molar ratio of the dimerized diamine to the bifunctional fatty amine is 1:0.4 to 1:3.

10. The preparation method of the polyimide oligomer of claim 5, wherein a molar ratio of a diamine to the dianhydride is 1.2:1 to 1.8:1, and the diamine is obtained by adding the dimerized diamine to the bifunctional fatty amine.

11. A cured product, wherein the cured product is prepared by adding a free radical initiator to the polyimide oligomer of claim 1 and baking at a curing temperature.

12. The cured product of claim 11, wherein the free radical initiator is peroxide, an azo initiator, or a combination thereof.

13. The cured product of claim 11, wherein an added amount of the free radical initiator is 0.3 weight percentage to 2 weight percentage of the polyimide oligomer.
